(19) United States
(12) Patent Application Publication
(10) Pub. No.: US 2015/0169948 A1
(43) Pub. Date: Jun. 18, 2015

(54) ELECTRONIC APPARATUS AND METHOD

(71) Applicant: Kabushiki Kaisha Toshiba, Tokyo (JP)

(72) Inventor: Shigeru Motoi, Kokubunji-shi (JP)

(73) Assignee: Kabushiki Kaisha Toshiba, Tokyo (JP)

(21) Appl. No.: 14/288,714

(22) Filed: May 28, 2014

(30) Foreign Application Priority Data
Dec. 13, 2013 (JP) 2013-258313

(51) Int. Cl. G06K 9/00; G06F 3/0488

(52) U.S. Cl. CPC G06K 9/00402; G06F 3/04883

(57) ABSTRACT

According to one embodiment, an electronic apparatus includes a display processor. The display processor is configured to display one or more first strokes on a touch screen display. The display processor is configured to display at least one candidate character string based on detection of a position and a direction of the one or more first strokes, the at least one candidate character string retrieved by using the one or more first strokes, and to display one or more second strokes of a first candidate character string based upon selection of the first candidate character string.

### CROSS-REFERENCE TO RELATED APPLICATIONS

This application is based upon and claims the benefit of priority from Japanese Patent Application No. 2013-258313, filed Dec. 13, 2013, the entire contents of which are incorporated herein by reference.

### FIELD

Embodiments described herein relate generally to technology of inputting characters by handwriting.

### BACKGROUND

Recently, various electronic apparatuses such as tablets, PDAs and smartphones have been developed. To facilitate users' input operations, most of the electronic apparatuses include a touch screen display and have a function for handwriting. Users can therefore create not only documents including texts and images, but also documents including handwritten characters or figures by using the electronic apparatuses.

Incidentally, a method of assisting the user's input by using a history of character strings which have ever been input when a user inputs a character string like a word has been provided.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an appearance of an electronic apparatus of an embodiment.

FIG. 2 is an illustration showing an example of a stroke handwritten on a touch screen display of the electronic apparatus of the embodiment.

FIG. 3 is an exemplary illustration for explaining time-series information (stroke data) corresponding to the handwritten stroke shown in FIG. 2, stored in a storage medium by the electronic apparatus of the embodiment.

FIG. 4 is an exemplary block diagram showing a system configuration of the electronic apparatus of the embodiment.

FIG. 5 is an illustration showing an example of displaying a candidate character string by a predictive input, on a screen on which a stroke is input by handwriting.

FIG. 6 is an illustration showing a first example of displaying a candidate character string based on a direction of a stroke handwritten by a right-handed user, by the electronic apparatus of the embodiment.

FIG. 7 is an illustration showing an example of displaying a candidate character string based on a direction of a stroke handwritten by a left-handed user, by the electronic apparatus of the embodiment.

FIG. 8 is an illustration showing a second example of displaying a candidate character string based on a direction of a stroke handwritten by a right-handed user, by the electronic apparatus of the embodiment.

FIG. 9 is an exemplary block diagram showing a functional configuration of a predictive input utility executed by the electronic apparatus of the embodiment.

FIG. 10 is a view showing a configuration example of handwritten character string data used by the electronic apparatus of the embodiment.

FIG. 11 is an illustration explaining an example of further inputting a stroke by handwriting when a candidate character string is displayed by the electronic apparatus of the embodiment.

FIG. 12 is an illustration explaining an example of further inputting a spot-like stroke by handwriting when a candidate character string is displayed by the electronic apparatus of the embodiment.

FIG. 13 is an illustration showing a third example of displaying a candidate character string in accordance with a direction of a stroke handwritten by the user and a region where a new stroke is expected to be handwritten, by the electronic apparatus of the embodiment.

FIG. 14 is an illustration showing an example of displaying candidate character strings in two regions, by the electronic apparatus of the embodiment.

FIG. 15 is an illustration showing an example of displaying a plurality of candidate character strings in accordance with a direction of a stroke handwritten by the user, by the electronic apparatus of the embodiment.

FIG. 16 is an exemplary flowchart showing the procedure of handwriting input processing executed by the electronic apparatus of the embodiment.

FIG. 17 is an exemplary flowchart showing the procedure of predictive input processing executed by the electronic apparatus of the embodiment.

### DETAILED DESCRIPTION

Various embodiments will be described hereinafter with reference to the accompanying drawings.

In general, according to one embodiment, an electronic apparatus includes a display processor. The display processor is configured to display one or more first strokes on a touch screen display. The display processor is configured to display at least one candidate character string based on detection of a position and a direction of the one or more first strokes, the at least one candidate character string retrieved by using the one or more first strokes, and to display one or more second strokes of a first candidate character string based upon selection of the first candidate character string.

FIG. 1 is a perspective view showing an appearance of an electronic apparatus according to the embodiment. The electronic apparatus is, for example, a pen-based portable electronic apparatus which may execute a handwriting input using a stylus or a finger. The electronic apparatus may be realized as a tablet computer, a notebook-type personal computer, a smartphone, a PDA, etc. In the following descriptions, it is assumed that the electronic apparatus is realized as a tablet computer 10. The tablet computer 10 is a portable electronic apparatus which is also called a tablet or a slate computer. The tablet computer 10 includes a main body 11 and a touch screen display 17 as shown in FIG. 1. The touch screen display 17 is mounted to be overlaid on a top surface of the main body 11.

The main body 11 includes a housing shaped in a thin box. A flat panel display and a sensor, which is configured to detect a contact position of a stylus or a finger on a screen of the flat panel display, are incorporated in the touch screen display 17. The flat panel display may be, for example, a liquid crystal display (LCD). As the sensor, for example, a capacitance type touch panel, an electromagnetic induction type digitizer, etc., may be employed. In the following descriptions, it is assumed that both two types of sensor, i.e., a digitizer and a touch panel, are incorporated in the touch screen display 17.

Each of the digitizer and the touch panel is provided to cover the screen of the flat panel display. The touch screen display 17 detects not only a touch operation on the screen using the finger, but also a touch operation on the screen using a stylus 100. The stylus 100 is, for example, an electromagnetic induction type stylus.

The user may perform a handwriting input operation to input a plurality of strokes by handwriting, on the touch screen display 17, by using an external object (stylus 100 or finger). In the handwriting input operation, a path of a movement of the external object (stylus 100 or finger) on the screen, i.e., a path of a stroke handwritten by the handwriting input operation (path of a handwritten stroke), is drawn in real time, and the path of each stroke is thereby displayed on the screen. The path of the movement of the external object formed while the external object is in contact with the screen corresponds to the stroke. A set of a number of strokes, i.e., a set of a number of paths (handwritten strokes) constitute a handwritten character or figure.

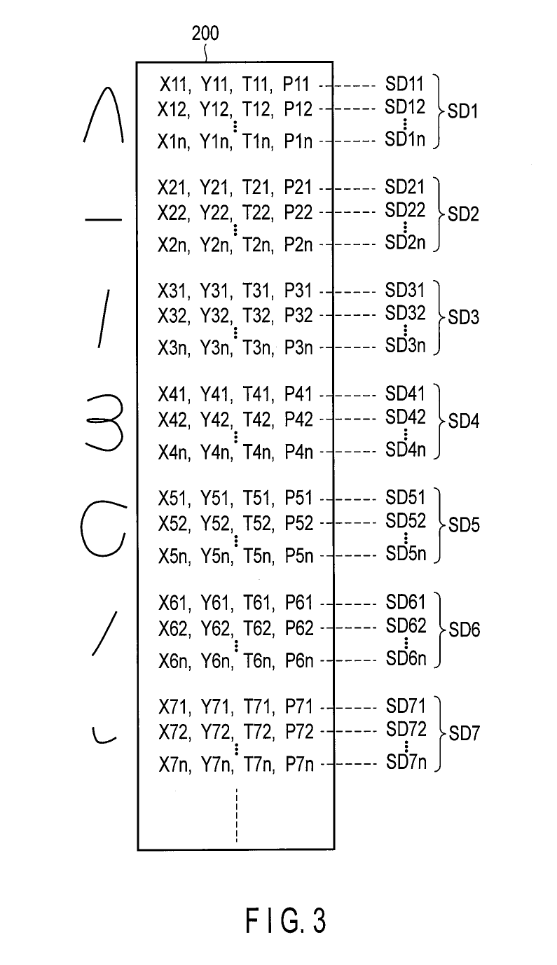

In the present embodiment, such handwritten strokes (handwritten characters and figures) are stored in a storage medium as not image data, but time-series information indicative of coordinates of paths of the respective strokes and a sequential relationship between the strokes. Details of the time-series information will be described later with reference to FIG. 3. The time-series information, generally, indicates a set of time-series stroke data corresponding to a plurality of strokes, respectively. Each stroke data may be any data capable of expressing a stroke which can be input by handwriting, and includes, for example, coordinate data series (time-series coordinates) corresponding to each of points on the path of the stroke. The alignment sequence of the elements of the stroke data corresponds to an order in which the strokes are handwritten, i.e. a handwriting order.

The tablet computer 10 reads existing arbitrary document data from the storage medium, and display on the screen the document corresponding to the document data, i.e., the handwritten document in which paths corresponding to a plurality of strokes represented by the time-series information, respectively, are drawn.

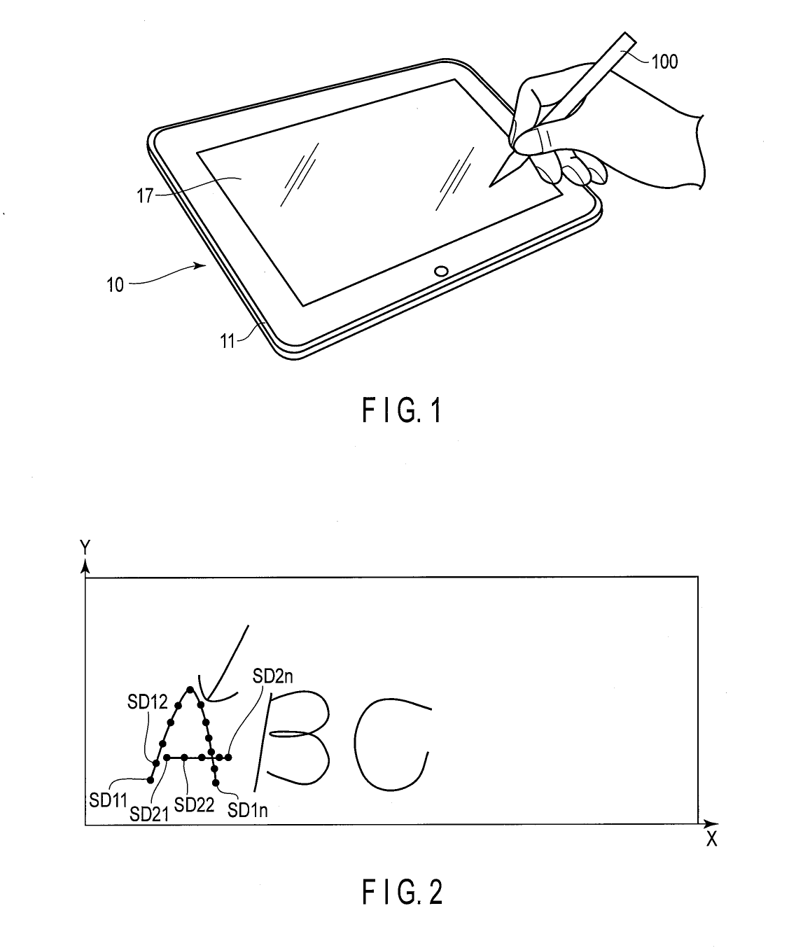

Next, with reference to FIGS. 2 and 3, a relationship between strokes (handwritten characters, graphics, marks, tables, etc.) handwritten by the user and the time-series information will be described. FIG. 2 shows an example of a document handwritten on the touch screen display 17 by using the stylus 100, etc.

In the document, once a character, figure, etc., are handwritten, another character, figure, etc. are often further handwritten thereon. In FIG. 2, it is assumed that a character string “ABC” is handwritten in order of “A”, “B”, and “C”, and then an arrow is handwritten in a position very close to the handwritten character “A”.

The handwritten character “A” is represented by two strokes (a path shaped in “Λ” and a path shaped in “-”) handwritten with the stylus 100, etc., i.e., by two paths. The first handwritten path of the stylus 100 shaped in “Λ” is sampled, for example, in real time at regular time intervals. Time-series coordinates SD11, SD12 . . . , SD1n of the stroke shaped in “Λ” are thereby obtained. Similarly, the next handwritten path of the pen 100 shaped in “-” is also sampled. Time-series coordinates SD21, SD22, SD2n of the stroke shaped in “-” are thereby obtained.

The handwritten character “B” is represented by two strokes handwritten with the stylus 100, etc., i.e., by two paths. The handwritten character “C” is represented by one stroke handwritten with the stylus 100, etc., i.e., by one path. The handwritten arrow is represented by two strokes handwritten with the stylus 100, etc., i.e., by two paths.

FIG. 3 shows time-series information 200 corresponding to the document of FIG. 2. The time-series information 200 includes a plurality of stroke data SD1, SD2, . . . SD7. In the time-series information 200, the stroke data SD1, SD2, . . . SD7 are aligned in time series, i.e., in order of handwriting a plurality of strokes.

In the time-series information 200, two leading stroke data SD1 and SD2 are indicative of the two strokes of the handwritten character “A”, respectively. The third and fourth stroke data SD3 and SD4 are indicative of two strokes which constitute the handwritten character “B”, respectively. The fifth stroke data SD5 is indicative of one stroke which constitutes the handwritten character “C”. The sixth and seventh stroke data SD6 and SD7 are indicative of the two strokes which constitute the handwritten arrow, respectively.

Each stroke data includes coordinate data series (time-series coordinates) corresponding to one stroke, i.e., a plurality of coordinates corresponding to a plurality of points on the path of one stroke. In each stroke data, the plurality of coordinates are aligned in time series, in order of writing strokes. For example, in the handwritten character “A”, stroke data SD1 includes the coordinate data series (time-series coordinates) corresponding to the points on the path of the “A”-shaped stroke of the handwritten character “A”, i.e., n coordinate data SD11, SD12, . . . SD1n. Stroke data SD2 includes coordinate data series corresponding to the points on the path of the stroke shaped in “-”, of the handwritten character “A”, i.e., n-number of coordinate data SD21, SD22, SD2n. The number of elements of the coordinate data may be different in each element of the stroke data.

Each coordinate data indicates an X coordinate and a Y coordinate corresponding to a certain point in the associated path. For example, coordinate data SD11 indicates the X coordinate (X11) and the Y coordinate (Y11) of the starting point of the stroke shaped in “κ”. SD1n indicates the X coordinate (X1n) and the Y coordinate (Y1n) of the end point of the stroke shaped in “κ”.

Each coordinate data may include time stamp information T representing the time point when a point corresponding to the coordinates is handwritten. The time point at which the point is handwritten may be either an absolute time (for example, year, month, day, hour, minute, and second) or a relative time based on a certain time point. For example, the absolute time (for example, year, month, day, hour, minute, and second) at which the stroke starts being handwritten may be added to each stroke data as time stamp information, and the relative time indicating a difference from the absolute time may be added as time stamp information T to each coordinate data in the stroke data. By using the time-series information in which the time stamp information T is added to each coordinate data, the temporal relationship between the strokes can be represented more accurately.

Furthermore, each coordinate data may include pressure P caused by bringing the external object (for example, stylus 100) into contact with the screen when the point corresponding to the coordinates is handwritten.

In the present embodiment, as described above, since the handwritten stroke is stored as not an image or a character recognition result, but the time-series information 200 composed of sets of time-series stroke data, the handwritten characters and figures can be handled without depending on a language. The structure of the time-series information 200 of the present embodiment can be therefore used commonly in various countries of the world where different languages are used.

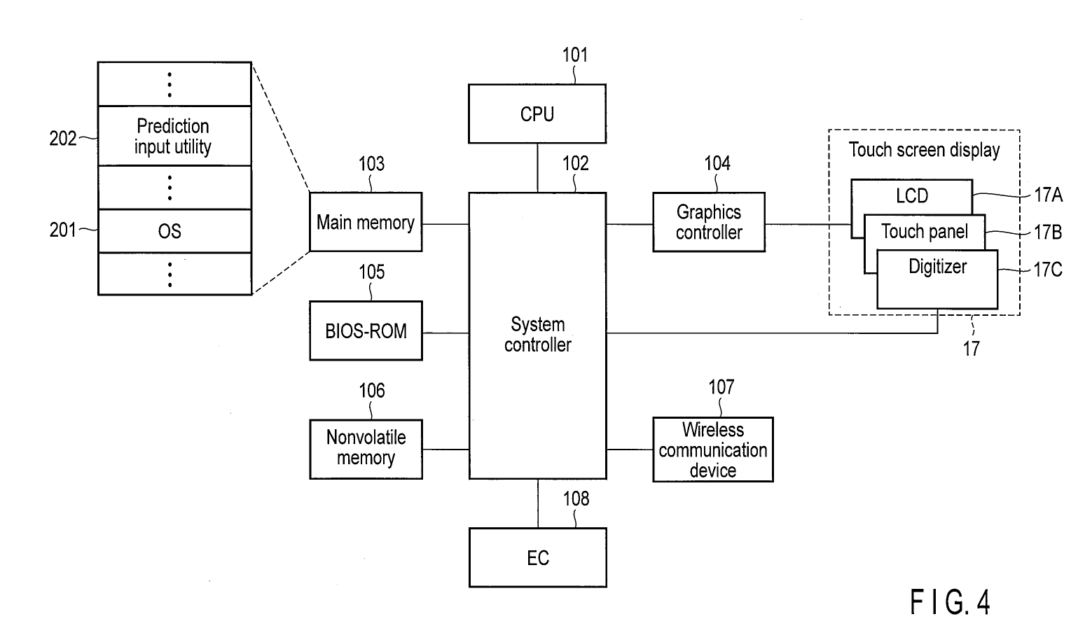

FIG. 4 is a diagram showing a system configuration of the tablet computer 10.

As shown in FIG. 4, the tablet computer 10 includes a CPU 101, a system controller 102, a main memory 103, a graphics controller 104, a BIOS-ROM 105, a nonvolatile memory 106, a wireless communication device 107, an embedded controller (EC) 108, etc.

The CPU 101 is a processor for controlling operations of various components in the tablet computer 10. The CPU 101 executes various types of software loaded into the main memory 103 from the nonvolatile memory 106 that is a storage device. The software includes an operating system (OS) 201 and various application programs. The application programs include a predictive input utility program 202. The predictive input utility program 202 has an predictive input function (suggest function) to present candidates of character strings which are expected to be input, based on one or more strokes input by handwriting. The predictive input utility program 202 realizes, for example, a function of suggesting a search keyword, a function of complementing the character string input in the document, etc. by the predictive input function.

In addition, the CPU 101 also executes a basic input/output system (BIOS) stored in the BIOS-ROM 105. The BIOS is a program for hardware control.

The system controller 102 is a device that makes connection between a local bus of the CPU 101 and various components. A memory controller for controlling access to the main memory 103 is also built in the system controller 102. The system controller 102 also has a function of executing communication with the graphics controller 104 via a serial bus of PCI EXPRESS standard.

The graphics controller 104 is a display controller that controls an LCD 17A which is utilized as a display monitor of the tablet computer 10. A display signal generated by the graphics controller 104 is sent to the LCD 17A. The LCD 17A displays a screen image in accordance with the display signal. On the LCD 17A, a touch panel 17B and a digitizer 17C are arranged. The touch panel 17B is a capacitance type pointing device used to allow the user to make an input on the screen of the LCD 17A. A contact position on the screen touched by a finger, movement of the contact position, etc. are detected by the touch panel 17B. The digitizer 17C is an electromagnetic induction type pointing device used to allow the user to make an input on the screen of the LCD 17A. A contact position on the screen touched by the stylus 100, movement of the contact position, a contact pressure, etc. are detected by the digitizer 17C.

The wireless communication device 107 is a device configured to execute wireless communication such as wireless LAN or 3G mobile communication. The EC 108 is a one-chip microcomputer including an embedded controller for power management. The EC 108 has a function of powering on or off the tablet computer 10 in accordance with a user operation of a power button.

As described above, the predictive input utility program 202 realized the function of suggesting a search keyword, the function of complementing the character string input in the document, etc. by utilizing the predictive input function.

FIG. 5 shows an example of displaying the candidate character string by the predictive input function when the character string is input by handwriting. The handwriting input of such a character string is, for example, handwriting input of a keyword for searching, handwriting input to be executed when a handwritten document file is created, etc.

A screen shown in FIG. 5 includes, for example, a handwriting input area 31 and a candidate character string area 32. The handwriting input area 31 is an area where strokes constituting the character string are input by handwriting, in accordance with detection of the contact of the stylus 100, etc. using the touch screen display 17. The candidate character string area 32 is an area where one or more character string candidates, which are expected to be input based on the character string input by handwriting in the handwriting input area 31, are displayed.

More specifically, if a handwritten character string “app” is input in the handwriting input area 31, i.e., if strokes 311 to 315 are input by handwriting, candidate character strings expected to be input based on the handwritten character string “app” are displayed in the candidate character string area 32. The candidate character strings are, for example, character strings (handwritten character strings) starting with character string “app”, i.e., “apple”, “approve” and “application” in order of higher likelihood to the character string “app” (strokes 311 to 315). If the candidate character strings include a character string which the user is to input, the user may instruct the candidate character string to be drawn in the handwriting input area 31 by selecting the candidate character string (i.e., tapping the candidate character string). For example, if the user selects character string “apple”, one or more strokes corresponding to the character string “apple” are drawn in the handwriting input area 31.

If any candidate character string is thus selected from the candidate character strings, the selected candidate character string is displayed in the handwriting input area 31. In other words, the input strokes 311 to 315 are replaced with one or more strokes corresponding to the selected candidate character string. On the other hand, if the character string which the user is to input is not included in the candidate character strings, the user further inputs a character (stroke) constituting the keyword in the handwriting input area 31 by handwriting.

Incidentally, the candidate character string area 32 is fixed at an upper part of the handwriting input area 31 in the example shown in FIG. 5. If the user handwrites the character string with the stylus 100, in the handwriting input area 31, and the character string to be input is displayed in the candidate character string area 32, the user moves the stylus 100 to a position where the candidate character string is displayed and selects (taps) the candidate character string. Therefore, the user needs to repeatedly move the stylus 100 widely, between the handwriting input area 31 and the candidate character string area 32, to input the character string by handwriting and select the candidate character string, and inputting may not be able to be accelerated irrespective of utilizing the predictive input function.

For this reason, the candidate character strings are displayed in positions corresponding to the direction (proceeding direction) and the position in which the user handwrites the strokes, in the present embodiment. The candidate character strings can be thereby displayed in the positions where the user can recognize the candidate character strings, easily and visually, and can easily select the character string, in the present embodiment.

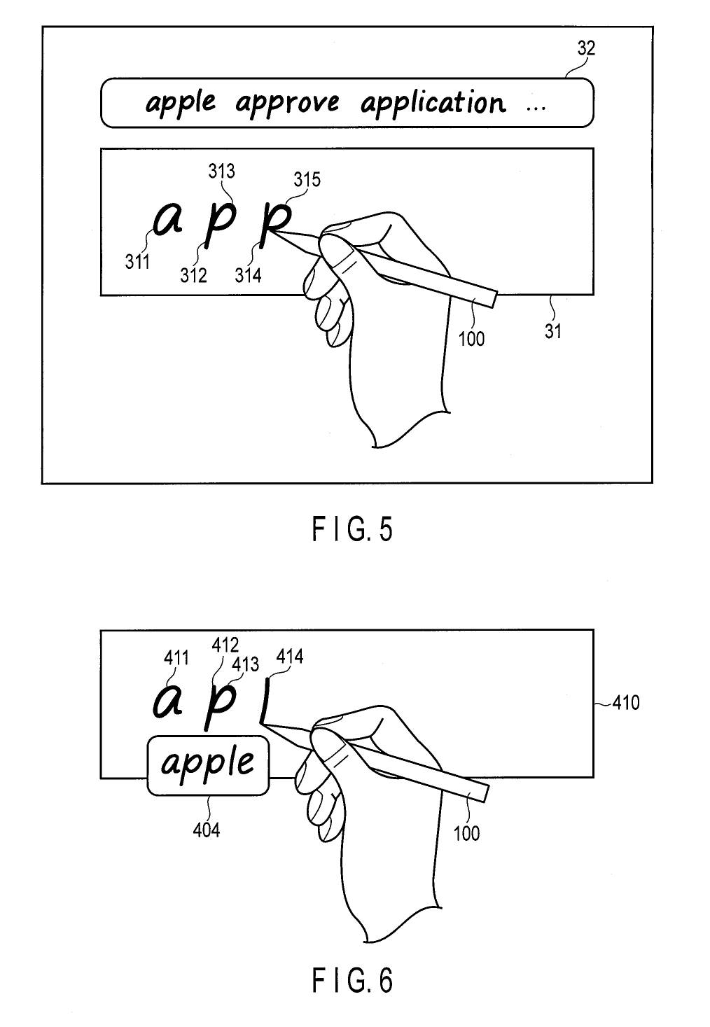

FIGS. 6 to 8 show examples of displaying the candidate character strings in consideration of the position and direction in which the stroke is handwritten by the user.

In the example shown in FIG. 6, handwritten character string “ap” (i.e., strokes 411, 412 and 413) is input in a handwriting input area 410 and then stroke 414 is further input. In this case, candidate character string “apple” 404 is displayed in accordance with the position and the direction in which the stroke 414 is handwritten. Since the user handwrites the stroke 414 from an upper side to a lower side, the candidate character string 404 is displayed in a position in extension of the stroke 414 in the direction from the upper side to the lower side.

Since the user is right-handed, in the example shown in FIG. 6, the candidate character string 404 (center of an area of the candidate character string 404) is moved from the position in the extension of the stroke 414 to a left side position, by a predetermined distance, such that the candidate character string 404 is not hidden by the user's hand.

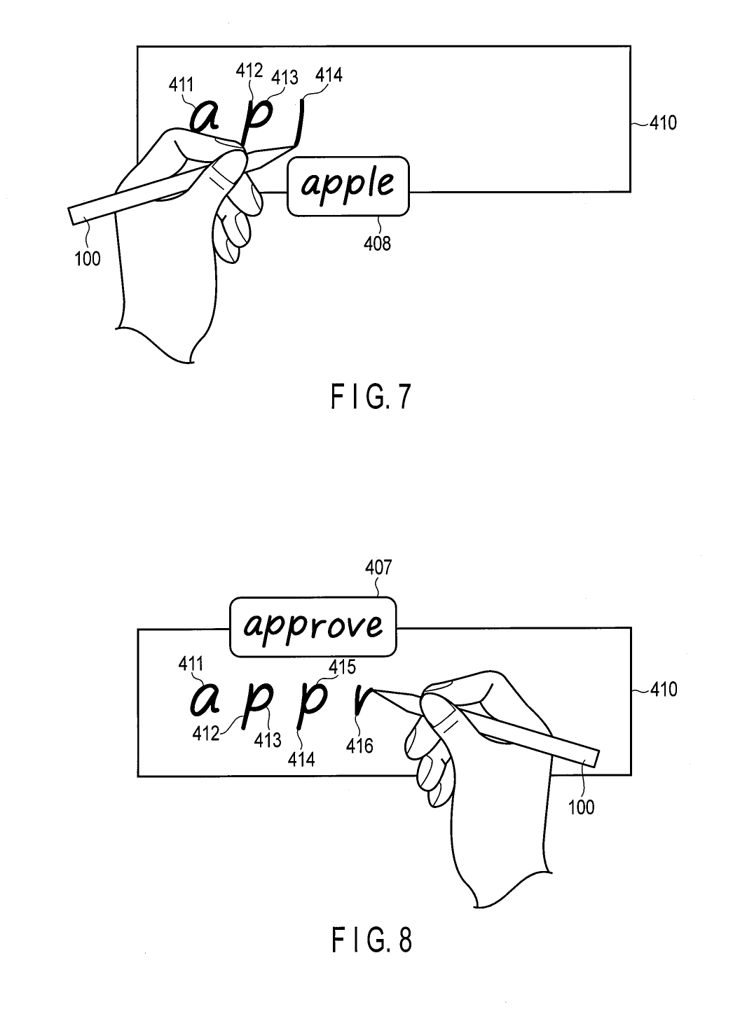

If the user is left-handed, as shown in FIG. 7, candidate character string 408 (center of an area of the candidate character string 408) is moved from the position in the extension of the stroke 414 to a right side position, by a predetermined distance, such that the candidate character string 408 is not hidden by the user's hand.

Next, in the example shown in FIG. 8, handwritten character string “app” (strokes 411 to 415) is input in the handwriting input area 410 and then stroke 416 is further input. In this case, candidate character string “approve” 407 is displayed in accordance with the position and the direction in which the stroke 416 is handwritten.

The stroke 416 is a part of the strokes constituting character “r”, and the direction in which the stroke is handwritten is changed within a stroke constituting the character “r”. In this case, the direction (vector) of the stroke is determined by using, for example, the several coordinate data within an immediately previous predetermined period, of the coordinate data corresponding to the handwritten stroke 416.

The user handwrites the part 416 of the stroke constituting the character “r”, from a lower left side to an upper right side, within an immediately previous predetermined period. For this reason, the candidate character string 407 is displayed in the position in the extension of the stroke 416 in the direction from a lower left side to an upper right side. In addition, the candidate character string 407 (i.e., center of the area of the candidate character string 407) is moved to the left side position from the position in the extension of the stroke 416 by a predetermined distance such that the candidate character string 407 is not hidden by the hand of the right-handed user.

The candidate character strings are thus displayed in the places where the user can recognize the candidate character strings, easily and visually, and can easily select the candidate character strings, by displaying the candidate character strings in the positions corresponding to the position and the direction (proceeding direction) in which the user handwrites the stroke. The user can therefore easily select the character string and accelerate the handwriting character input.

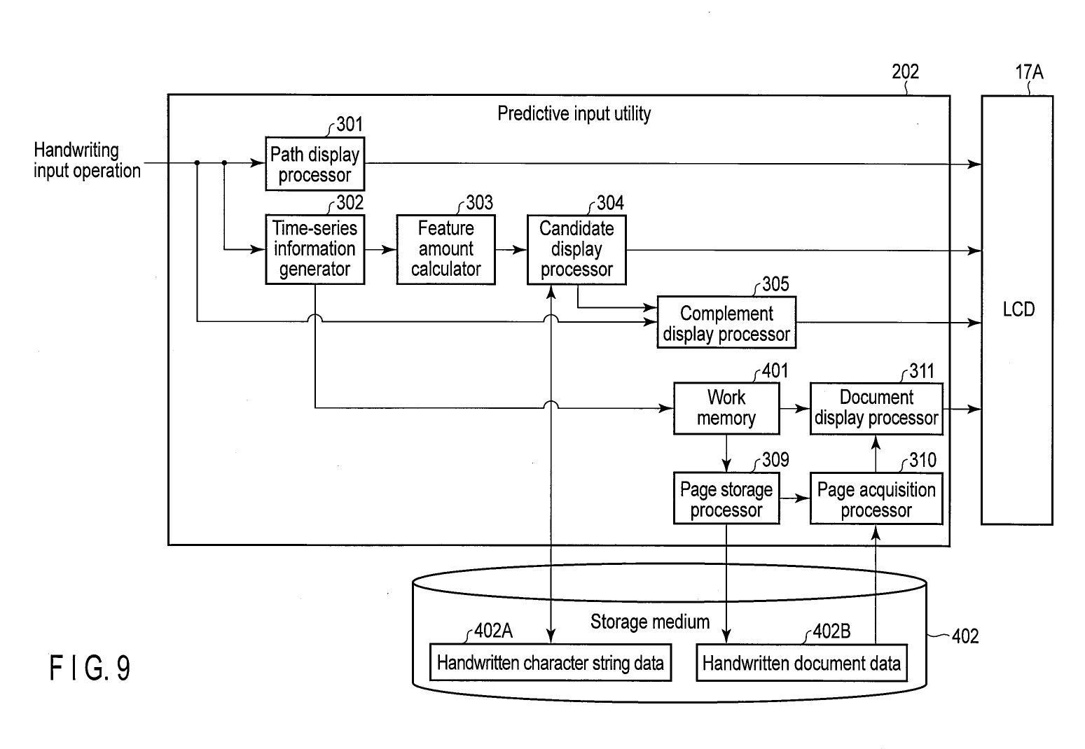

FIG. 9 shows an example of a functional configuration of the predictive input utility program 202. The predictive input utility program 202 executes displaying at least one candidate character string retrieved by using a handwritten character string, overwriting the handwritten character string with the selected candidate character string, etc. by using the time-series information (stroke data) input by the operation utilizing the touch screen display 17.

The predictive input utility program 202 includes, for example, a path display processor 301, a time-series information generator 302, a feature amount calculator 303, a candidate display processor 304, a complement display processor 305, a page storage processor 309, a page acquisition processor 310, and a document display processor 311.

The touch screen display 17 is configured to detect occurrence of events such as “Touch”, “Move (Slide)” and “Release”. “Touch” is an event indicating that an external object has been in contact with the screen. “Move (Slide)” is an event indicating that the contact position has been moved while the external object is in contact with the screen. “Release” is an event indicating that the external object has been released from the screen.

The path display processor 301 and the time-series information generator 302 receive the event

“Touch”, “Move (Slide)” or “Release” which occurs by the touch screen display 17, and thereby detects the handwriting input operation. Coordinates of the contact position are included in the “Touch” event. Coordinates of the contact position of a movement destination are included in the “Move (Slide)” event. Therefore, the path display processor 301 and the time-series information generator 302 can receive coordinates corresponding to the path of the movement of the contact position from the touch screen display 17.

The path display processor 301 displays one or more strokes (hereinafter also referred to as one or more first strokes) input by handwriting stroke on the screen of the touch screen display 17. The path display processor 301 receives the coordinates from the touch screen display 17, and displays a path of each stroke handwritten by the handwriting input operation using the stylus 100, etc. on the screen of the LCD 17A in the touch screen display 17, based on the received coordinates. The path of the stylus 100 formed while the stylus 100 is in contact with the screen, i.e., the stroke is drawn on the screen of the LCD 17A by the path display processor 301.

The time-series information generator 302 receives the coordinates output from the touch screen display 17, and generates time-series information (stroke data) having a structure as described in detailed in FIG. 3, based on the received coordinates. In this case, the time-series information, i.e., coordinates and time stamp information corresponding to each point of the stroke may be temporarily stored in a work memory 401.

In addition, the time-series information generator 302 outputs the generated time-series information (stroke data) to the feature amount calculator 303. The time-series information generator 302 outputs the stroke data, for example, for coordinates of each point on the stroke in real time. Every time a stroke is input by handwriting, the time-series information generator 302 may output the stroke data corresponding to the stroke to the feature amount calculator 303.

The feature amount calculator 303 and the candidate display processor 304 display on the screen at least one handwritten candidate character string retrieved by using the one or more first strokes displayed on the screen by the path display processor 301, of handwritten character strings included in a handwritten document corresponding to handwritten document data 402B as stored in a storage medium 402.

A plurality of handwritten character string data 402A corresponding to a plurality of handwritten character strings included in the handwritten document may be stored in the storage medium 402. By using the plurality of handwritten character string data 402A corresponding to a plurality of handwritten character strings, the feature amount calculator 303 and the candidate display processor 304 display the handwritten character candidates corresponding to the one or more first strokes displayed on the screen, of the plurality of handwritten character strings, in a position corresponding to the direction and the position in which the one or more first strokes are input. The handwritten character string data 402A includes a feature amount corresponding to the one or more strokes constituting the handwritten character strings. The handwritten character string having the highest likelihood to the feature amount corresponding to the one or more first strokes is displayed in a position based on the direction and the position in which the strokes are input, by using the handwritten character string data 402A.

More specifically, the feature amount calculator 303 calculates the feature amount (first feature amount) using one or more stroke data corresponding to the one or more first strokes generated by the time-series information generator 302. The feature amount calculator 303 calculates, for example, the feature amount based on the shapes, handwriting directions, etc. of the one or more first strokes.

Next, the candidate display processor 304 calculates the likelihood of each candidate character string, using the calculated first feature amount and a second feature amount corresponding to the candidate character string in the handwritten character string data 402A.

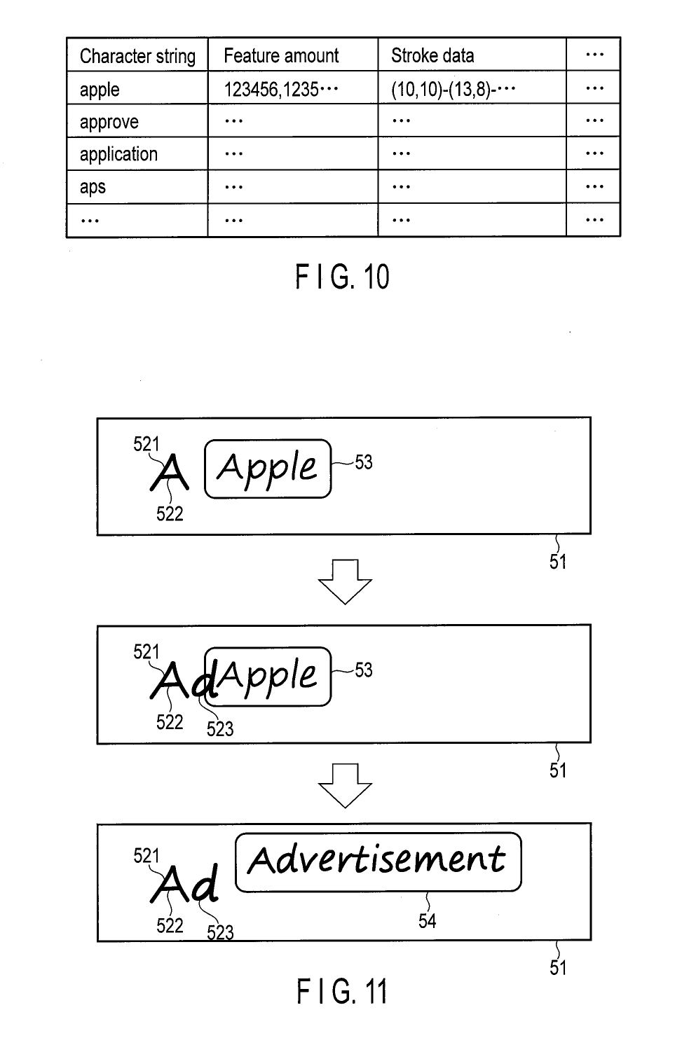

FIG. 10 shows a configuration example of the handwritten character string data 402A. The handwritten character string data 402A is generated by analyzing, for example, the stroke data corresponding to the handwritten strokes or the handwritten document data 402B. The handwritten character string data 402A is, for example, generated for each user.

The handwritten character string data 402A includes a plurality of entries corresponding to a plurality of handwritten character strings. Each entry includes, for example, character string, feature amount and stroke data. In the entry corresponding to a handwritten character string, “character string” indicates a text (character codes) corresponding to the handwritten character string. The “feature amount” indicates a feature amount corresponding to one or more strokes constituting the handwritten character string. The “stroke data” indicates stroke data (time-series information) corresponding to one or more strokes constituting the handwritten character string.

In the “character string”, for example, the text (character codes) which is obtained by subjecting a character recognition processing to the stroke data indicated by the “stroke data” is set. In the “feature amount”, for example, the feature amount based on the stroke shape and the direction of handwriting the stroke as calculated by using the stroke data indicated by the “stroke data” is set.

For example, if one or more first strokes input by handwriting are the strokes constituting an arbitrary character string (for example, a set of characters such as words and phrases) and if the character string is being input (i.e., if handwriting input of all the strokes constituting the character string is not completed), the candidate display processor 304 calculates the likelihood of the candidate character string by using the feature amount (first feature amount) corresponding to the one or more first strokes and the feature amount (second feature amount) corresponding to the candidate character string in the handwritten character string data 402A. The candidate display processor 304 calculates the likelihood corresponding to each of the plurality of candidate character strings in the handwritten character string data 402A.

The candidate display processor 304 then detects the candidate character string having the highest likelihood, of the plurality of candidate character strings in the handwritten character string data 402A. The candidate display processor 304 may sort the plurality of candidate character strings in descending order of calculated likelihood.

Next, the candidate display processor 304 determines the position where the detected candidate character string is displayed. For example, the candidate display processor 304 determines the position where the candidate character string is displayed, based on the position and the direction in which the stroke is handwritten. For example, by using a predetermined number of the latest coordinate data, of the stroke data (coordinate data string) corresponding to the latest stroke handwritten by the user, the candidate display processor 304 detects the direction (vector) in which the stroke is input during the latest predetermined period. Then, the candidate display processor 304 determines the position remote from the position indicated by the last coordinate data in the coordinate data string corresponding to the stroke, in the detected direction, by a predetermined distance, as a position where the candidate character string is to be displayed. In other words, the candidate display processor 304 determines the position in extension of the latest stroke as the position where the candidate character string is to be displayed. The candidate display processor 304 displays the candidate character string in the determined position.

The candidate display processor 304 may display the candidate character string in a different position by further considering which of the right hand and the left hand is used to execute the handwriting input operation (i.e., which hand is a user's dominant hand). For example, the candidate display processor 304 determines which of the right hand and the left hand is used by the user to execute the handwriting input operation, by using a value indicating the dominant hand preset by the user. In addition, the candidate display processor 304 may determine which of the right hand and the left hand is used by the user to execute the handwriting input operation, based on a relationship between the contact position of the stylus 100 detected at the handwriting input operation and the hand contact position (for example, the left side or the right side of the pen which the hand contacts).

A first position in which the candidate character string is displayed when the one or more first strokes handwritten are input by the user's right hand, is set at a left side of a second position in which the one or more first strokes are input by the user's left hand. If the user executes the handwriting input operation by the right hand, the candidate display processor 304 changes the position determined in the above manner to, for example, a position moved to a left side by a predetermined distance such that the candidate character string is not hidden by the right hand. In addition, if the user executes the handwriting input operation by the left hand, the candidate display processor 304 changes the position determined in the above manner to, for example, a position moved to a right side by a predetermined distance such that the candidate character string is not hidden by the left hand.

More specifically, in the examples shown in FIGS. 6 and 7, the feature amount calculator 303 calculates the first feature amount corresponding to the strokes 411 to 414 by using the stroke data corresponding to the strokes 411 to 414. The candidate display processor 304 calculates the likelihood of each candidate character string by using the calculated first feature amount and a plurality of feature amounts corresponding to the plurality of candidate character strings in the handwritten character string data 402A. The candidate display processor 304 determines the candidate character string having the highest likelihood, “apple”, of the plurality of candidate character strings in the handwritten character string data 402A.

Next, the candidate display processor 304 displays the candidate character string in a position based on the position and direction in which the stroke 414 is handwritten. The candidate display processor 304 detects the direction in which the stroke 414 is handwritten (i.e., vector of the stroke), by using the predetermined number of the latest coordinate data, of the stroke data (coordinate data strings) corresponding to the stroke 414 latest handwritten by the user. The candidate display processor 304 determines the position remote from the position indicated by the last coordinate data of the coordinate data strings corresponding to the stroke 414, by the predetermined distance (i.e., first distance), in the detected direction, as a position where the candidate character string is to be displayed.

If the user's dominant hand is further considered, the candidate display processor 304 displays the candidate character string at a different position, based on the user's right hand or left hand used to input one or more first strokes, such that the candidate character string is not hidden by the user's hand used to execute the handwriting input operation. In other words, when the user executes the handwriting input operation by the right hand (FIG. 6), the candidate display processor 304 moves the determined position to a left-side position by a predetermined distance (second distance). On the other hand, when the user executes the handwriting input operation by the left hand (FIG. 7), the candidate display processor 304 moves the determined position to a right-side position by a predetermined distance (second distance). The candidate display processor 304 displays the candidate character string in the determined position.

In addition, in the example shown in FIG. 8, the feature amount calculator 303 calculates the first feature amount corresponding to the strokes 411 to 416, by using the stroke data corresponding to the strokes 411 to 416. The candidate display processor 304 calculates the likelihood of each candidate character string by using the calculated first feature amount and a plurality of feature amounts corresponding to the plurality of candidate character strings in the handwritten character string data 402A. The candidate display processor 304 determines the candidate character string having the highest likelihood, “approve”, of the plurality of candidate character strings in the handwritten character string data 402A.

Next, the candidate display processor 304 displays the candidate character string in a position based on the position and direction in which the stroke 416 is handwritten. The candidate display processor 304 detects the direction in which the stroke 416 is handwritten (i.e., vector of the stroke), by using the predetermined number of the latest coordinate data, of the stroke data (coordinate data strings) corresponding to the stroke 416 latest handwritten by the user. The candidate display processor 304 determines the position remote from the position indicated by the last coordinate data of the coordinate data strings corresponding to the stroke 416, by the predetermined distance (i.e., first distance), in the detected direction, as a position where the candidate character string is to be displayed.

If the user's dominant hand is further considered, the candidate display processor 304 displays the candidate character string at a different position, based on the user's right hand or left hand used to input one or more first strokes, such that the candidate character string is not hidden by the user's hand used to execute the handwriting input operation. In other words, when the user executes the handwriting input operation by the right hand (FIG. 8), the candidate display processor 304 moves the determined position to a left-side position by a predetermined distance (second distance). Then, the candidate display processor 304 displays the candidate character string in the determined position.

The candidate display processor 304 may update the content of the candidate character string and the position where the candidate character string is displayed, in real time, based on the stroke data (coordinate data series) corresponding to the input stroke. In addition, the candidate display processor 304 may update the content of the candidate character string and the position where the candidate character string is displayed, every time inputting a stroke has been completed.

Next, if the displayed candidate character string is selected by a tapping operation, etc. on the touch screen display 17, the complement display processor 305 displays one or more second strokes constituting the candidate character string. For example, by replacing one or more first strokes (i.e., strokes constituting the character string which is being input) with one or more second strokes constituting the selected candidate character string, the complement display processor 305 displays the one or more second strokes on the screen.

More specifically, the complement display processor 305 first reads the stroke data corresponding to the selected candidate character string from the handwritten character string data 402A. The complement display processor 305 deletes the one or more first strokes on the screen and draws the one or more second strokes based on the read stroke data in the position where the one or more first strokes have been drawn. The complement display processor 305 may delete the stroke data corresponding to the one or more first strokes in the work memory 401 and temporarily store the stroke data corresponding to the one or more second strokes in the work memory 401.

If the displayed candidate character string is not selected and the stroke is further input by handwriting, a new candidate character string is displayed by further considering the stroke.

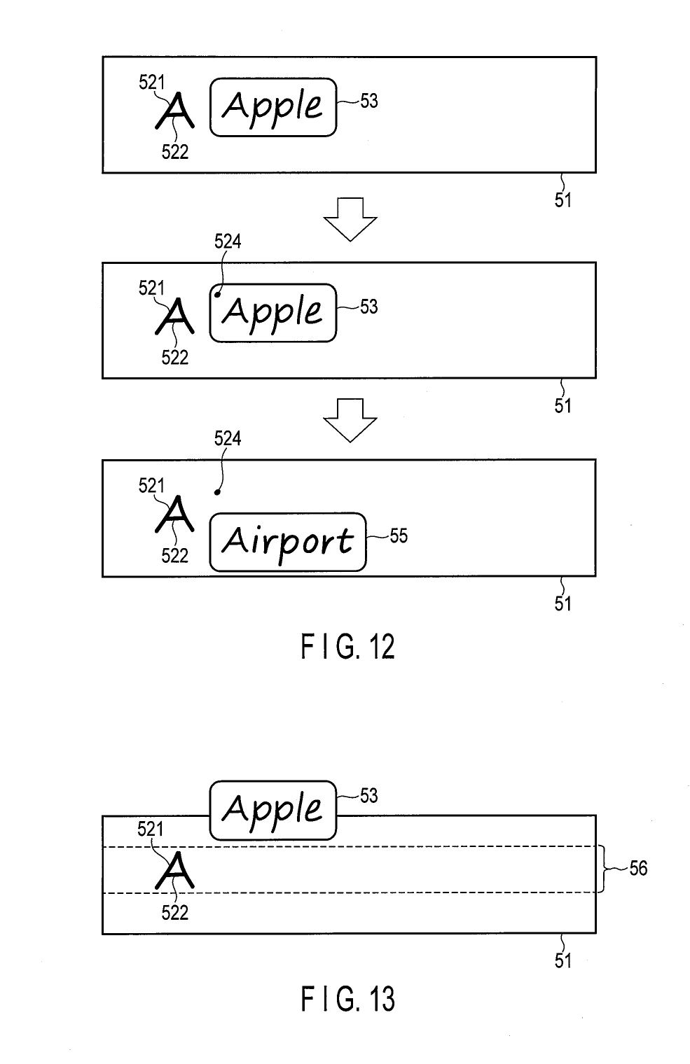

Further inputting the stroke when the candidate character string is displayed will be described with reference to FIGS. 11 and 12. The user is assumed to be left-handed in the examples shown in FIGS. 11 and 12.

In the example shown in FIG. 11, handwritten character “A”, i.e., handwritten strokes 521 and 522 are input and candidate character string “Apple” 53 corresponding to the strokes 521 and 522 is displayed, in handwriting input area 51. The candidate display processor 304 displays the candidate character string 53 in a position based on a position and a direction in which the second stroke 522 constituting the handwritten character “A” is handwritten. By using the predetermined number of latest coordinate data, of the stroke data (coordinate data strings) corresponding to the stroke 522, the candidate display processor 304 detects a direction (vector) in which the stroke 522 is handwritten. Then, the candidate display processor 304 detects the position remote from the position indicated by the last coordinate data of the coordinate data string corresponding to the stroke 522, by a predetermined distance, in the detected direction, as a position where the candidate character string 53 is to be displayed. In other words, the candidate display processor 304 determines the position in the extension of the latest stroke 522 as the position where the candidate character string 53 is to be displayed. Since the user handwrites the stroke 522 in the direction from the left side to the right side, the candidate character string 53 is displayed in the position in the extension of the stroke 522 from the left side to the right side.

When the user is to input the character string “Apple”, the user selects (taps) the candidate character string 53. The complement display processor 305 replaces the strokes 521 and 522 drawn in the handwriting input area 51 with strokes corresponding to the candidate character string 53, in accordance with, for example, the tapping operation on the region corresponding to the candidate character string 53. The tapping operation is, for example, a contact operation for a period shorter than a threshold time (for example, 0.5 seconds). As described above, since the candidate character string 53 is displayed in the position in the extension of the stroke 522, the user can easily select the candidate character string 53 without widely moving the stylus 100, etc.

On the other hand, when the user is to input the character string which is not “Apple”, the user further handwrites the stroke 523. Since the candidate character string 53 is displayed in the position where stroke 523 is handwritten, the user handwrites the stroke 523 (i.e., stroke of the character “d”) on the region of the candidate character string 53.

If a contact operation is executed in the region corresponding to the candidate character string 53 and if the contact operation is part of the operation of inputting the stroke by handwriting, the path display processor 301 and the time-series information generator 302 process the contact operation as not the selection of the candidate character string 53, but the handwriting input operation of the stroke. That is, the path display processor 301 displays the stroke 523 input by handwriting on the screen of the touch screen display 17. In addition, the time-series information generator 302 receives the coordinates output from the touch screen display 17 and generates the time-series information (i.e., stroke data) corresponding to the stroke 523 based on the received coordinates.

The feature amount calculator 303 calculates a feature amount of the newly input stroke 523. The candidate display processor 304 calculates the likelihood of each candidate character string, by using the feature amounts of the already input strokes 521 and 522, the feature amount of the newly input stroke 523, and a plurality of feature amounts of a plurality of candidate character strings included in the handwritten character string data 402A. The candidate display processor 304 determines new candidate character string “Advertisement” 54 having the highest likelihood. The candidate display processor 304 displays the candidate character string 54, based on the position and the direction of handwriting the stroke 523. The candidate display processor 304 detects that the stroke 523 is handwritten in a direction from a lower left side to an upper right side, by using, for example, the predetermined number of the latest coordinate data, of the stroke data (coordinate data string) corresponding to the stroke 523 of character “d”. For this reason, the candidate display processor 304 displays the candidate character string 54 in a position remote from the position indicated by the last coordinate data of the coordinate data string corresponding to the stroke 523, by a predetermined distance, in the direction from the lower left side to the upper right side.

In the example shown in FIG. 12, too, the handwritten character “A”, i.e., the handwritten strokes 521 and 522 are input in the handwriting input area 51, and the candidate character string “Apple” 53 corresponding to the strokes 521 and 522 is displayed.

If the user is to input a character string which is not “Apple”, the user further handwrites stroke 524. The stroke 524 is, for example, a first stroke of character “i”, which is a spot-like stroke. The spot-like stroke 524 may be handled as a tapping operation in the region corresponding to the candidate character string 53, by the complement display processor 305, and the candidate character string 53 which is not intended for the user may be selected.

For this reason, in the present embodiment, it is discriminated whether the user's contact operation is the tapping operation or the operation of inputting a stroke by handwriting, based on the contact time of the stylus 100, etc. in the region corresponding to the candidate character string 53. The complement display processor 305 discriminates that the user's operation is the tapping operation, in accordance with, for example, the detection of the contact operation for a period shorter than the threshold period, and executes processing which should be executed when the candidate character string 53 is selected. In other words, the complement display processor 305 replaces the strokes 521 and 522 drawn in the handwriting input area 51 with strokes corresponding to the candidate character string 53, in response to the detection of the contact operation for a period shorter than the threshold period.

On the other hand, the candidate display processor 304 discriminates that the user's operation is the operation of inputting a stroke by handwriting, in accordance with a contact operation for a period equal to or longer than the threshold period or a contact operation in a length equal to or longer than a threshold distance (i.e., a contact operation corresponding to a path in a length equal to or longer than a threshold distance), and executes the processing which should be executed when the stroke 524 is input. More specifically, the path display processor 301 displays the stroke 524 corresponding to the path of the contact operation, while continuing the display of one or more first strokes 521, 522. In addition, the time-series information generator 302 receives the coordinates output from the touch screen display 17, and generates time-series information (stroke data) of the stroke 524 based on the received coordinates. The feature amount calculator 303 calculates a feature amount of the stroke 524. The candidate display processor 304 calculates the likelihood of each candidate character string, by using the feature amounts of the already input strokes 521 and 522, the feature amount of the newly input stroke 524, and a plurality of feature amounts of a plurality of candidate character strings included in the handwritten character string data 402A. The candidate display processor 304 determines new candidate character string “Airport” 55 having the highest likelihood. The candidate display processor 304 displays the candidate character string 55, based on the position and the direction of handwriting the stroke 523. The candidate display processor 304 detects that the stroke 524 is handwritten in a direction from an upper side to a lower side, by using, for example, the predetermined number of the latest coordinate data, of the stroke data (coordinate data string) corresponding to the stroke 524. For this reason, the candidate display processor 304 displays a candidate character string 55 in a position remote from the position indicated by the last coordinate data of the coordinate data string corresponding to the stroke 524, by a predetermined distance, in the direction from the upper side to the lower side.

The user can thereby instruct the selection of the candidate character string 53 by executing the contact operation (i.e., tapping operation) for the contact period shorter than the threshold period, in the region corresponding to the candidate character string 53. In addition, the user can instruct input of a short stroke such as a spot-like stroke, separately from the selection of the candidate character string 53, by executing the contact operation (i.e., operation of inputting the stroke by handwriting) for the contact period longer than the threshold period, in the region corresponding to the candidate character string 53.

In the examples shown in FIGS. 11 and 12, the candidate character string 53 is displayed in accordance with the user's input of the strokes 521 and 522, and the candidate character string 53 is displayed in the position in which the next stroke 523 is expected to be handwritten. Such display of the candidate character string 53 may be a problem in view of easy view of the strokes and easy input of the strokes.

For this reason, the candidate display processor 304 may display the candidate character string in a position other than a position in which the next stroke is to be handwritten. The candidate display processor 304 displays the candidate character string, based on the position where the stroke is presumed to be input subsequently to one or more first strokes that have been already input, by the user. The candidate display processor 304 displays the candidate character string in a different position, for example, based on whether one or more strokes handwritten by the user correspond to a horizontal writing character string or a vertical writing character string.

If one or more strokes handwritten by the user constitute a horizontal writing character string, the candidate display processor 304 displays the candidate character string 53 at an upper side or a lower side of the line region corresponding to the horizontal writing character string. In the example shown in FIG. 13, the candidate character string 53 is displayed at an upper side than a region 56 corresponding to the horizontal writing line including character string “A” 521 and 522. In other words, the position of the candidate character string 53 shown in FIGS. 11 and 12 is moved vertically (upwardly or downwardly), in a region other than the region 56 of the horizontal writing line.

Similarly, if one or more strokes handwritten by the user constitute a vertical writing character string, the candidate display processor 304 displays the candidate character string 53 at a left side or a right side of the line corresponding to the vertical writing character string (stroke). In other words, the position of the candidate character string is moved horizontally (leftwardly or rightwardly), in a region other than the region of the vertical writing line.

In addition, the page storage processor 309 stores the generated stroke data (i.e., stroke data temporarily stored in the work memory 401), as the handwritten document data 402B, in the storage medium 402. The storage medium 402 is, for example, a storage device in the tablet computer 10.

The page acquisition processor 310 reads from the storage medium 402 arbitrary handwritten document data 402B that has been already stored in the storage medium 402. The read handwritten document data 402B is sent to the document display processor 311. The document display processor 311 analyzes the handwritten document data 402B and displays on the screen the document (page) including the path of each stroke indicated by the stroke data (time-series information), based on the analysis result.

In the above-described structure, the candidate of the character string which is expected to be input can be presented effectively. The candidate display processor 304 determines the candidate character string for a stroke, by using the feature amount corresponding to the stroke input by handwriting using the stylus 100, etc., and a plurality of feature amounts corresponding to a plurality of handwritten character strings indicated by the handwritten character string data 402A. Then, the candidate display processor 304 displays the determined candidate character string in a position on the screen based on the position and direction of handwriting the stroke. Thus, if the candidate character string is the character string which the user is to input, the user can easily select the candidate character string without widely moving the stylus 100, etc.

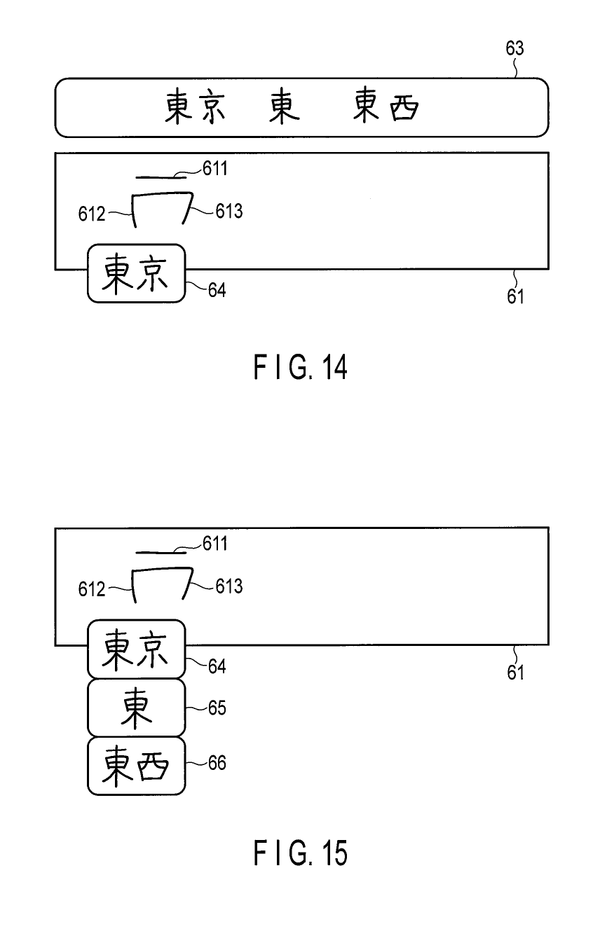

Since the stroke data corresponding to the stroke is used, the present embodiment may also be applied to characters such as Kanji characters, other than Alphabet letters, as shown in FIGS. 13 and 14.

In the example shown in FIG. 14, when candidate character string 64 corresponding to strokes 611 to 613 is displayed, other candidate character strings having high likelihood to the strokes 611 to 613 are displayed in candidate character string area 63. The candidate character strings displayed in the candidate character string area 63 are, for example, the predetermined number of top-ranked candidate character strings of candidate character strings sorted in descending order of the likelihood to the strokes 611 to 613. The user can thereby select the character string, of a plurality of candidate character strings displayed in the candidate character string area 63.

Furthermore, in the example shown in FIG. 15, the predetermined number of top-ranked candidate character strings 64 to 66 are aligned in positions based on a position and a direction of handwriting latest stroke 613. The candidate character strings 64 to 66 having higher likelihood are arranged in positions closer to the position of latest handwriting. The user can thereby easily select the character string which the user is to input, of the plurality of candidate character strings 64 to 66, without widely moving the stylus 100, etc.

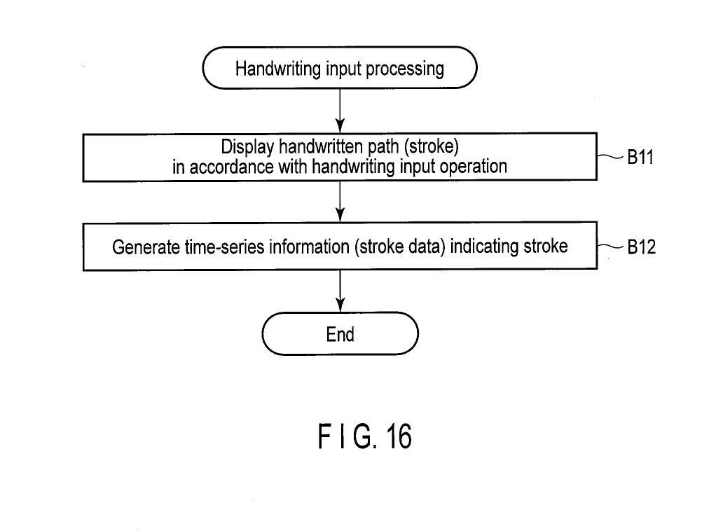

Next, an example of the procedure of handwriting input processing executed by the predictive input utility program 202 will be described with reference to a flowchart of FIG. 16.

The path display processor 301 displays the path (stroke) of the movement of the stylus 100, etc. formed by the handwriting input operation on the document (block B11). The time-series information generator 302 generates the above-described time-series information (i.e., the stroke data aligned in order of time series), based on the coordinates corresponding to the path formed by the handwriting input operation, and temporarily stores the generated time-series information in the work memory 401 (block B12).

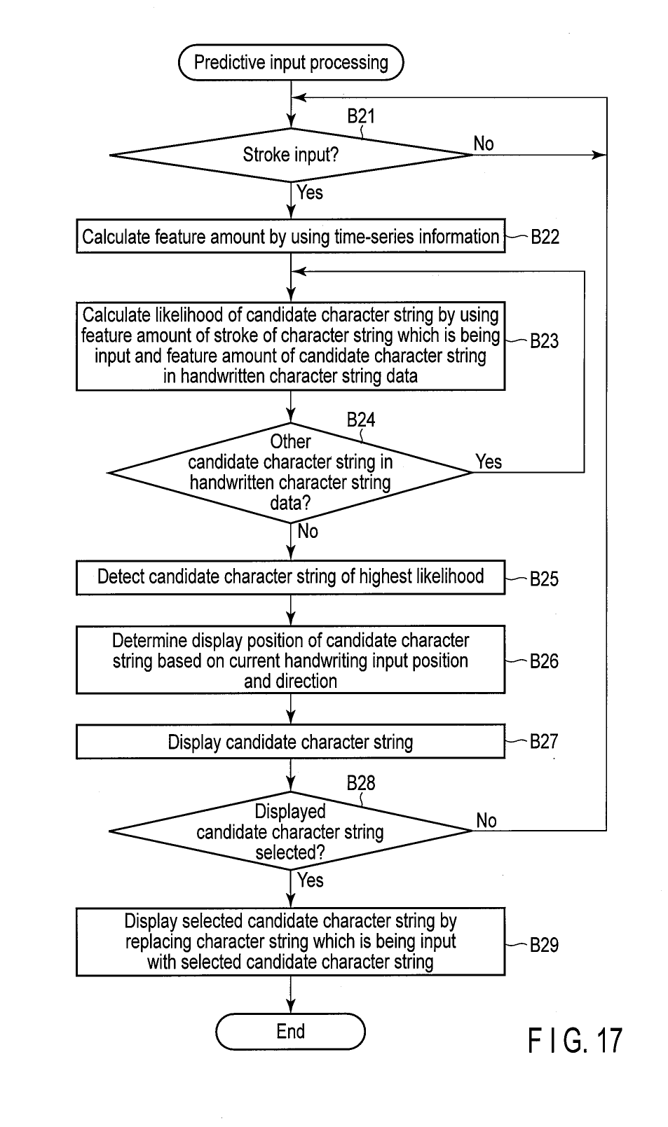

In addition, a flowchart of FIG. 17 shows an example of the procedure of predictive input processing executed by the predictive input utility program 202.

The feature amount calculator 303 determines whether the handwritten stroke is input (block B21). The feature amount calculator 303 determines that the handwritten stroke is input if, for example, the feature amount calculator 303 receives the stroke data corresponding to the handwritten stroke from the time-series information generator 302. If the handwritten stroke is not input (No in block B21), the processing returns to block B21 and it is determined again whether the handwritten stroke is input.

If the handwritten stroke is input (Yes in block B21), the feature amount calculator 303 calculates the feature amount by using the time-series information (stroke data) which corresponds to the handwritten stroke and is generated by the time-series information generator 302 (block B22). The candidate display processor 304 calculates the likelihood of the candidate character string by using the calculated feature amount (first feature amount) and the feature amount (second feature amount) corresponding to the candidate character string in the handwritten character string data 402A (block B23). More specifically, if the first stroke is a stroke constituting a character string (character) which is being input, the candidate display processor 304 calculates the likelihood of the candidate character string by using the feature amount (first feature amount) corresponding to one or more handwritten strokes constituting the character string which is being input, including the calculated feature amount, and the feature amount (second feature amount) corresponding to the candidate character string in the handwritten character string data 402A. In addition, if the input first stroke is a leading stroke constituting the character string, the candidate display processor 304 calculates the likelihood of the candidate character string by using the calculated feature amount (first feature amount) and the feature amount (second feature amount) corresponding to the candidate character string in the handwritten character string data 402A. The candidate display processor 304 calculates higher likelihood as, for example, similarity of the first feature amount to the second feature amount is higher.

Next, the candidate display processor 304 determines whether an entry of the other candidate character string (i.e., an entry of a candidate character string having likelihood which has not yet been calculated) is included in the handwritten character string data 402A or not (block B24). If the entry of the other candidate character string is included in the handwritten character string data 402A (Yes in block B24), the processing returns to block B23 and the likelihood of the candidate character string is calculated.

If the entry of the other candidate character string is not included in the handwritten character string data 402A, i.e., if the likelihoods of all the candidate character strings are calculated (No in block B24), the candidate display processor 304 detects the candidate character string of the highest likelihood (block B25). The candidate display processor 304 determines a display position of the detected candidate character string, based on the current (latest) handwriting input position and the current (latest) handwriting input direction (block B26). Then, the candidate display processor 304 displays the candidate character string in the determined display position (block B27).

Next, the complement display processor 305 determines whether the displayed candidate character string is selected (block B28). The complement display processor 305 determines that the displayed candidate character string is selected if, for example, the tapping operation is detected in the region corresponding to the displayed candidate character string. If the candidate character string is not selected (No in block B28), the processing returns to block B21 and a candidate character string in which a newly input stroke is further considered is displayed based on the input position and input direction of the stroke.

If the candidate character string is selected (Yes in block B28), the complement display processor 305 displays one or more handwritten strokes corresponding to the selected candidate character string by replacing one or more handwritten strokes corresponding to the character string which is being input as displayed on the screen with the one or more handwritten strokes corresponding to the selected candidate character string, by using the stroke data corresponding to the selected character string (block B29).

The predictive input utility program 202 can be utilized in association with all types of software in which characters are input by handwriting (for example, Web-browsers, mailers, word processing software, spreadsheet software, etc.)

As described above, according to the present embodiment, the candidate of the character string which is expected to be input can be presented effectively.

The path display processor 301 displays one or more first strokes on the touch screen display 17. The candidate display processor 304 displays at least one candidate character string, which is retrieved by using the one or more first strokes, based on detection of a position and a direction of the one or more first strokes. The complement display processor 305 displays one or more second strokes of a first candidate character string of the at least one candidate character string based upon selection of the first candidate character string.

Thus, the candidate character string can be thereby displayed in a location where the user can recognize the candidate character string, easily and visually, or can easily select the candidate character string. Since the user can smoothly select the candidate character string or input subsequent strokes, inputting characters by handwriting can be accelerated.

All the procedures in the present embodiment, which have been described with reference to flowcharts of FIGS. 16 and 17, can be executed by software. Thus, the same advantageous effects as with the present embodiment can easily be obtained simply by installing a computer program, which executes the process procedures, into an ordinary computer through a computer-readable storage medium which stores the computer program, and by executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising
a display processor configured to display one or more first strokes on a touch screen display,
the display processor is configured to:
display at least one candidate character string based on detection of a position and a direction of the one or more first strokes, the at least one candidate character string retrieved by using the one or more first strokes; and
display one or more second strokes of a first candidate character string based upon selection of the first candidate character string.

2. The apparatus of claim 1, wherein the display processor is configured to display the at least one candidate character string in a different position, based on whether the one or more first strokes are input by a user's right hand or a user's left hand.

3. The apparatus of claim 2, wherein a first position in which the at least one candidate character string is displayed when the one or more first strokes are input by the user's right hand is at a left side of a second position in which the at least one candidate character string is displayed when the one or more first strokes are input by the user's left hand.

4. The apparatus of claim 1, wherein the display processor is configured to display the at least one candidate character string in a different position, based on whether the one or more first strokes correspond to a horizontal writing character string or a vertical writing character string.

5. The apparatus of claim 4, wherein the display processor is configured to:
display the at least one candidate character string at an upper side or a lower side of a line adjacent to a region comprising the horizontal writing character string when the one or more first strokes correspond to the horizontal writing character string; and
display the at least one candidate character string at a left side or a right side of a line adjacent to a region comprising the vertical writing character string when the one or more first strokes correspond to the vertical writing character string.

6. The apparatus of claim 1, wherein the display processor is configured to display the one or more second strokes by replacing the one or more first strokes, in response to detection of a contact operation for a period shorter than a threshold period in a region comprising the first candidate character string.

7. The apparatus of claim 1, wherein the display processor is configured to display a third stroke corresponding to a path of a contact operation while continuing the display of the one or more first strokes, in response to detection of the contact operation for a period equal to or longer than a threshold period or in a distance equal to or longer than a threshold distance, in a region comprising the first candidate character string.

8. The apparatus of claim 1, wherein the display processor is configured to display the at least one candidate character string, based on an estimated position of a stroke to be input, subsequently with the one or more first strokes.

9. A method of displaying using an electronic apparatus comprising:
displaying one or more first strokes on a touch screen display;
displaying at least one candidate character string based on detection of a position and a direction of the one or more first strokes, the at least one candidate character string retrieved by using the one or more first strokes; and
displaying one or more second strokes of a first candidate character string based upon selection of the first candidate character string.

10. The method of claim 9, wherein displaying the at least one candidate character string comprises displaying the at least one candidate character string in a different position, based on whether the one or more first strokes are input by a user's right hand or a user's left hand.

11. The method of claim 9, wherein displaying the at least one candidate character string comprises displaying the at least one candidate character string in a different position, based on whether the one or more first strokes correspond to a horizontal writing character string or a vertical writing character string.

12. The method of claim 9, wherein displaying the one or more first strokes comprises displaying a third stroke corresponding to a path of a contact operation while continuing the display of the one or more first strokes, in response to detection of the contact operation for a period equal to or longer than a threshold period or in a distance equal to or longer than a threshold distance, in a region comprising the first candidate character string.

13. The method of claim 9, wherein displaying the at least one candidate character string comprises displaying the at least one candidate character string, based on an estimated position of a stroke to be input, subsequently with the one or more first strokes.

14. A computer-readable, non-transitory storage medium having stored thereon a program which is executable by a computer, the program controlling the computer to execute functions of:
displaying one or more first strokes on a touch screen display;
displaying at least one candidate character string based on detection of a position and a direction of the one or more first strokes, the at least one candidate character string retrieved by using the one or more first strokes; and
displaying one or more second strokes of a first candidate character string based upon selection of the first candidate character string.

15. The storage medium of claim 14, wherein displaying the at least one candidate character string comprises displaying the at least one candidate character string in a different position, based on whether the one or more first strokes are input by a user's right hand or a user's left hand.

16. The storage medium of claim 14, wherein display the at least one candidate character string comprises displaying the at least one candidate character string in a different position, based on whether the one or more first strokes correspond to a horizontal writing character string or a vertical writing character string.

17. The storage medium of claim 14, wherein displaying the one or more first strokes comprises displaying a third stroke corresponding to a path of a contact operation while continuing the display of the one or more first strokes, in response to detection of the contact operation for a period equal to or longer than a threshold period or in a distance equal to or longer than a threshold distance, in a region comprising the first candidate character string.

18. The storage medium of claim 14, wherein displaying the at least one candidate character string comprises displaying the at least one candidate character string, based on an estimated position of a stroke to be input, subsequently with the one or more first strokes.
